(19) United States
(12) Patent Application Publication
(10) Pub. No.: US 2016/0323251 A1
(43) Pub. Date: Nov. 3, 2016

(54) METHOD, DEVICE AND EQUIPMENT FOR ENSURING DATA SECURITY

(71) Applicant: Lenovo Enterprise Solutions (Singapore) Pte. Ltd., Singapore (SG)

(72) Inventors: Mehul M. Shah, Austin, TX (US); WenWei Tang, Shanghai (CN); Yufeng Zhou, Shanghai (CN); Nian Nian Xia, ShangHai (CN); Weiyi Xie, Wuxi (CN)

(21) Appl. No.: 15/141,875

(22) Filed: Apr. 29, 2016

(30) Foreign Application Priority Data
Apr. 30, 2015 (CN) 20152200384

(51) Int. Cl. H04L 29/06; G06F 13/42; G06F 17/30; H04L 9/30; H04L 9/14

(52) U.S. Cl. CPC H04L 63/0428; H04L 63/06; H04L 9/30; H04L 9/14; G06F 17/30312; G06F 13/4282

(57) ABSTRACT

A method includes a firmware layer of a computing device receiving data input via a data input device, the received data being inaccessible by an operating system layer of the computing device, the data is to be sent to a remote server, and the firmware layer being independent of the operating system layer. The method further includes the firmware layer encrypting the received data, and the operating system layer sending the encrypted data to the remote server. A computing device includes a data input device, an operating system layer, and a firmware layer, wherein the computing device is capable of performing the method.

### CROSS-REFERENCE TO RELATED APPLICATIONS

This application claims priority under 35 U.S.C. §119 from Chinese Patent Application No. 20152200384, filed on Apr. 30, 2015, the entire text of which is specifically incorporated by reference herein.

### BACKGROUND

1. Field of the Invention

Various embodiments of the present invention relate to data security, and in particular, relate to a method, a computing device and an apparatus for ensuring data security.

2. Background of the Related Art

With the development of computer technologies and network technologies, computers have gradually become a prevalent part of most every person's work and life. For example, industries such as banks and securities are no longer limited to providing traditional offices, but now provide online services. With the popularity of online services, large amounts of sensitive user information, such as bank accounts, bank passwords and the like, are being transmitted over networks. However, current technology fails to ensure full security of a network transmission, and the current data acquisition is subject to attack by malicious programs such as Trojan programs.

With respect to various industries, particularly financial industries such as banking and securities, ensuring users' data security when the users are enjoying online services is currently a technical focus in the field of data security.

### BRIEF SUMMARY

One embodiment of the present invention provides a method. The method comprises: receiving data input via a data input device at a firmware layer of a computing device, the data being inaccessible by an operating system layer of the computing device, the data is to be sent to a remote server, and the firmware layer being independent of the operating system layer; encrypting the received data on the firmware layer; and the operating system layer sending the encrypted data to the remote server.

Another embodiment of the present invention provides a computing device. The computing device comprises: a data input device; an operating system layer; and a firmware layer, operable to: receive data input via a data input device, the data being inaccessible by an operating system layer, the data is to be sent to a remote server, and the firmware layer being independent of the operating system layer; and encrypt the received data on the firmware layer such that the operating system layer sends the encrypted data to the remote server.

Still another embodiment of the present invention provides an apparatus. The apparatus comprises: a data input device; a data acquiring module configured to receive data input via a data input device, the data being inaccessible by an operating system layer, the data is to be sent to a remote server, and the firmware layer being independent of the operating system layer; and a data encrypting module configured to encrypt the received data on the firmware layer such that the operating system layer sends the encrypted data to the remote server.

### BRIEF DESCRIPTION OF THE SEVERAL VIEWS OF THE DRAWINGS

The features, advantages and other aspects of the embodiments of the present invention would become more apparent with reference to the accompanying drawings and the description hereinafter. Several embodiments of the present invention are illustrated in an exemplary manner instead of a limiting manner. In the drawings:

FIG. 1 is a block diagram of an exemplary computer system.

FIGS. 2A and 2B are schematic diagrams of implementations of data security according to a various technical solutions.

FIG. 3 is an architecture diagram of a technical solution for ensuring data security according to an embodiment of the present invention.

FIG. 4 is a flow diagram of a method for ensuring data security according to an embodiment of the present invention.

FIG. 5 is a schematic diagram of a session identifier according to an embodiment of the present invention.

FIG. 6 is a schematic diagram of interactions among devices via a network according to an embodiment of the present invention.

FIG. 7 is a block diagram of a computing device for ensuring data security according to an embodiment of the present invention.

### DETAILED DESCRIPTION

The preferred embodiments of the present invention are hereinafter described in detail with reference to the accompanying drawings. Although the accompanying drawings illustrate the preferred embodiments of the present invention, it shall be understood that the present invention may be practiced in various manners, and shall not be limited by the embodiments illustrated herein. On the contrary, these embodiments are described herein only for the purpose of better understanding and integrity of the present invention, and may integrally convey the scope of the present invention to a person skilled in the art.

Embodiments of the present invention provide a technical solution for ensuring data security, which may be capable of conveniently and efficiently ensuring data security without modifying current hardware configurations of a computing device.

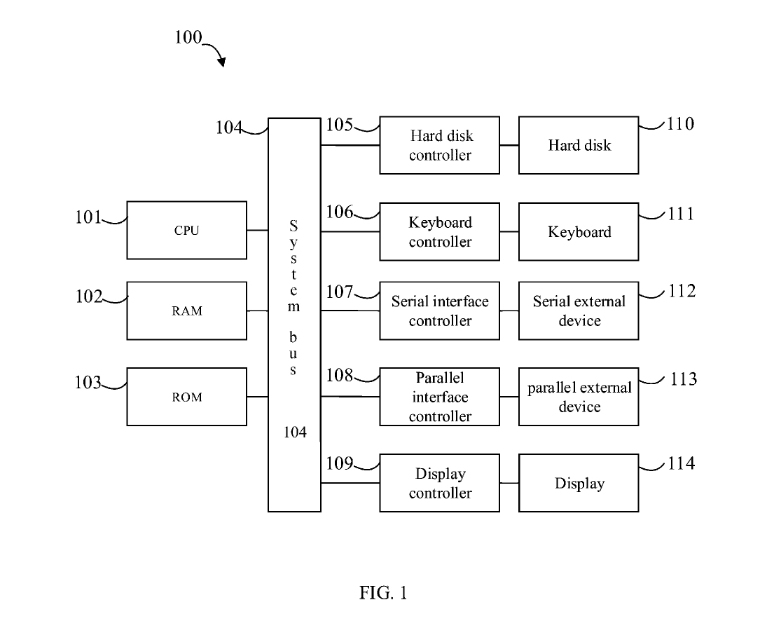

FIG. 1 is a block diagram of an exemplary computer system 100 according to an embodiment of the present invention. As illustrated in FIG. 1, the computer system 100 may comprise a central processing unit (CPU) 101, a random access memory (RAM) 102, a read-only memory (ROM) 103, a system bus 104, a hard disk controller 105, a keyboard controller 106, a serial interface controller 107, a parallel interface controller 108, a display controller 109, a hard disk 110, a keyboard 111, a serial external device 112, a parallel external device 113 and a touch screen display 114. In these devices, the CPU 101, the RAM 102, the ROM 103, the hard disk controller 105, the keyboard controller 106, the serial interface controller 107, the parallel interface controller 108 and the display controller 109 are coupled to the system bus 104. The hard disk 110 is coupled to the hard disk controller 105, the keyboard 111 is coupled to the keyboard controller 106, the serial external device 112 is coupled to the serial interface controller 107, the parallel external device 113 is coupled to the serial interface controller 108, and the touch screen display 114 is coupled to the display controller 109. It should be understood that the structural block diagram as illustrated in FIG. 1 is merely for illustration purposes, instead of limiting the scope of the present invention. Under some circumstances, some of the components or devices shown in FIG. 1 may be added or reduced according to the actual needs.

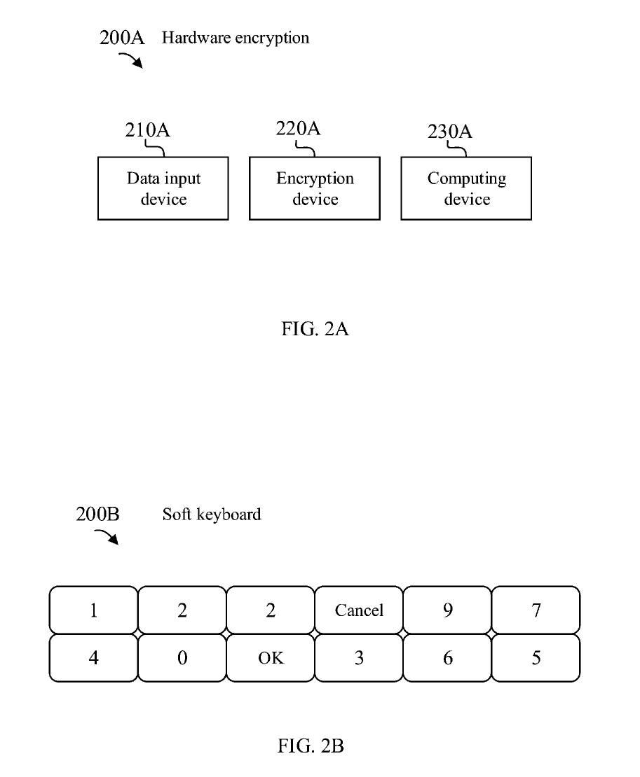

It should be noted that in the context of the specification, an exemplary computer system which is capable of practicing the embodiments of the present invention is schematically illustrated. In the context of the present invention, various programming languages may be used in various computer systems to implement the method, device and apparatus for ensuring data security according to the present invention. For example, while sensitive data (for example, a bank account code, password and the like) may be input to a computer device by a user via a data input device, a malicious program in the computing device may intercept the sensitive data input by the user. According to various embodiments of the present invention, the sensitive data input by the user may be encrypted to ensure data security. To be specific, FIGS. 2A and 2B provide diagrams of an implementation of data security according to one embodiment of the present invention.

In FIG. 2A, a block diagram illustrates a first technical solution for encrypting data by using hardware encryption technology. As shown, an encryption device 220A is coupled between a data input device 210A and a computing device 230A (for example, the computer system 100 as illustrated in FIG. 1). It should be noted that the encryption device 220A herein is a dedicated device configured to encrypt the data input via the data input device 210A. However, the encryption device 220A occupies an additional physical space and requires an increase in hardware investment.

In FIG. 2B, a block diagram illustrates a second technical solution based on a soft keyboard. Since a malicious program on the operating system layer may capture a key press event when the user presses a key on a physical keyboard, this technical solution proposes inputting sensitive data based on a soft keyboard or virtual keyboard. Accordingly, the user may click various keys in the soft keyboard by using a mouse. However, operation of the soft keyboard may not be convenient and the malicious program may speculate, by means of analyzing movement and hover time of the mouse, that sensitive data is being input by the user.

One embodiment of the present invention provides a method that avoids the shortcomings of the technical solutions in FIGS. 2A and 2B. The method comprises receiving data input via a data input device at a firmware layer of a computing device, the data being inaccessible by an operating system layer of the computing device, the data is to be sent to a remote server, and the firmware layer being independent of the operating system layer. The method further comprises encrypting the received data at the firmware layer (i.e., the firmware layer encrypts the data), and the operating system layer sending the encrypted data to the remote server.

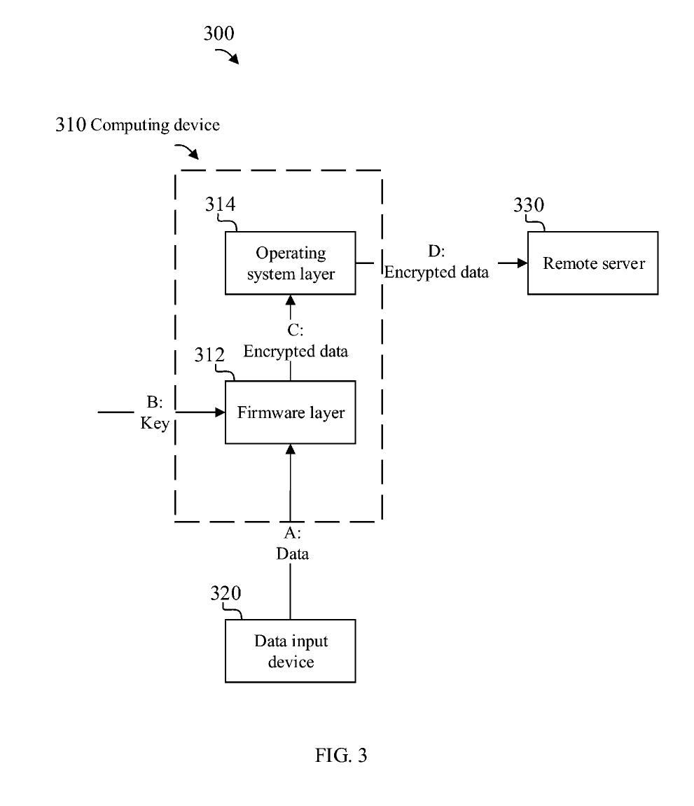

FIG. 3 is an architecture diagram 300 of a technical solution for ensuring data security according to an embodiment of the present invention. As illustrated in FIG. 3, a data input device 320 is coupled to a computing device 310. In this embodiment, data (as illustrated by arrow A) is input via the data input device 320 and is received by a firmware layer 312 of the computing device 310. It should be noted that in this embodiment, since the firmware layer 312 is located between an operating system 314 and the data input device 320 of the computing device 310, the firmware layer 312 is independent of the operating system layer 314, and the data received by the firmware layer 312 is inaccessible by the operating system layer 314 of the computing device 310. In this step, the received data may be sensitive information (for example, a bank account code, password and the like) input by the user, and the data is encrypted in the subsequent steps and then sent to a remote server 330.

After receiving the data, the data is encrypted on the firmware layer 312. In this embodiment, various encryption algorithms which are known in the related art or would be developed in the near future may be used to encrypt the received data. For example, the data may be encrypted based on the encryption key received as illustrated by arrow B. As illustrated by arrow C, the encrypted data may be transmitted to the operating system layer 314.

Subsequently, as illustrated by arrow D, the encrypted data is sent to the remote server 330.

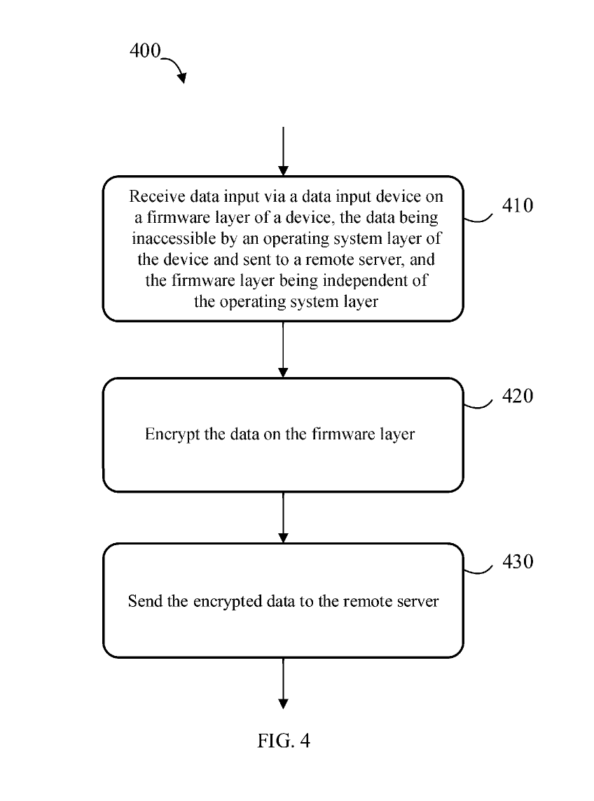

FIG. 4 is a flow diagram 400 of a method for ensuring data security according to an embodiment of the present invention. As illustrated in FIG. 4, in step 410, data input via a data input device is received by a firmware layer of a computing device, wherein the data is inaccessible by an operating system layer of the computing device, the data is to be sent to a remote server, and the firmware layer is independent of the operating system layer.

In the context of the present invention, step 410 may be performed by a Unified Extensible Firmware Interface (UEFI) as a specific example. It should be noted that the UEFI is an interface standard and the priorities of various operations on the UEFI layer are higher than the priorities of the operations on the operating system layer. Therefore, various operations may be performed on the UEFI layer in a manner of being transparent to the operating system layer.

It may be considered that the UEFI is an extension of a basic input/output system (BIOS), and the UEFI is firmware responsible for performing hardware startup and detection and the like operations during startup of the computing system. In addition, the UEFI acts as a medium for controlling hardware (for example, the data input device) during operation of the computing system. The UEFI is much more flexible than the BIOS, and may implement more functions based on programming. In the context of the present invention, various steps of the present invention may be practiced based on programming on the firmware layer.

In step 420, the data is encrypted on the firmware layer. In this step, for example, the data may be encrypted on the firmware layer by using various encryption algorithms. It should be noted that in the context of the present invention, since the sensitive data has been encrypted on the firmware layer, in this case even if a malicious program is present in the computing device, the malicious program may not access unencrypted data received by the firmware layer because the malicious program is located on the operating system layer of the computing device.

Thus, even if a malicious program is present in the computing device, the malicious program is only capable of accessing the data that is also accessible by the operating system layer, that is, only capable of accessing the encrypted data. In other words, since the unencrypted data is invisible to the operating system layer and only encrypted data is visible to the operating system layer, even if a malicious program has accessed a copy of the encrypted data, the malicious program is incapable of obtaining the sensitive data within the encrypted data since it is encrypted. Therefore, steps 410 and 420 may ensure that the sensitive data is invisible to the malicious program, thereby ensuring data security.

Subsequently, in step 430, the encrypted data is sent to the remote server. In this step, the encrypted data may be sent to the remote server via the network. In this manner, even if a malicious program is present on the operating system layer of the computing device or at a position in the network, the malicious program is only capable of accessing the encrypted data, thereby ensuring data security.

Details of the other embodiments of the present invention are described further hereinafter. In one embodiment of the present invention, the step of receiving data comprises receiving the data at the firmware layer based on a System Management Interrupt (SMI) having a priority higher than a priority of performing an operation on the operating system layer.

The SMI is an interrupt having a higher priority in the computing device, wherein the interrupt may be triggered by an event associated with a control board, a chip set, an input/output operation and the like. In the context of the present invention, the SMI may be triggered by the user's operation of inputting sensitive data via the data input device, and therefore, the sensitive data input by the user may be received by the firmware layer.

It should be noted that the data input by the user via the data input device may not necessarily be sensitive data. For example, when the user accesses a website of a bank, the input bank account code and password is sensitive data, whereas information input by the user on the website for searching the bank's business hours is not sensitive data. Therefore, in one embodiment of the present invention, it may be firstly determined whether the data input by the user is sensitive data, and only when the data input by the user is the sensitive data, the method described above with reference to FIG. 4 begins.

A person skilled in the art may employ a plurality of manners to cause the firmware to determine whether the input data is sensitive data, for example, by firstly determining whether the cursor is currently located in an input field of the bank account code, password or the like. Alternatively, a person skilled in the art may cause the firmware to determine whether the input data is sensitive data in any other manner.

In one embodiment of the present invention, the step of receiving the data at the firmware layer based on a SMI comprises enabling a System Management Mode (SMM) in response to detection of the SMI in the computing device, and reading the data input via the data input device in the SMM.

The SMM is transparent to the operating system, and may be enabled upon detecting the SMI. In other words, the operating system does not know when the computing device enters/exits the SMM and what operations are performed under the SMM. Therefore, even if a malicious program is present on the operating system layer, the malicious program does not know what operations are performed by the computing device under the SMM. Therefore, the process of reading the data input via the data input device in the SMM is invisible to the malicious program, thereby ensuring data security.

In one embodiment of the present invention, the data input device is any device which is coupled to the computing system and is capable of inputting data to the computing system. For example, the data input device may be a customary keyboard, a keypad, or any other device which is capable of inputting data to the computing device. It should also be noted that in the context of the present invention, it is not limited via which interface the data input device is coupled to the computing device, and the data input device may be coupled to the computing device via various standard interfaces which are known in the related art or would be developed in the near future. As a specific example only, the data input device may be a keyboard coupled to the computing device via a universal serial bus (USB) or a personal system 2 (PS/2) interface.

In one embodiment of the present invention, the data input device is a keyboard coupled to the computing device via a PS/2 interface, and the step of reading the data input via the data input device in the SMM comprises indicating that the SMI is triggered by a keyboard event interface in response to a byte from a first port of the PS/2 interface and reading the data from a second port of the PS/2.

The PS/2 interface is a commonly used interface for connecting an external device to the computing device, and may determine the data input via the keyboard by detecting data at various ports in the interface. To be specific, in the SMM, the data at the port 0x64 (a first port) may be detected, wherein 0 indicates that the user presses a key on the keyboard (that is, the current SMI is triggered by pressing the key), and the data input by the user may be read at port 0x60 (a second port).

The details of reading the data input by the user are described hereinafter with reference to a specific example. When the user presses key “a” on the PS/2 keyboard, the computing device enters the SMM due to the SMI. In this case, the byte “0” at port 0x64 of the interface indicates that the user pressed the key on the keyboard, and the byte at port 0x60 of the interface indicates that the user pressed a key on the keyboard (for example, the key “a”).

In one embodiment of the present invention, the step of reading the data input via the data input device in the SMM further comprises indicating that the SMI is triggered by a mouse event interrupt in response to the byte from the first port and waiting for a next System Management Interrupt.

A person skilled in the art shall note that the user's operations on the keyboard and the mouse may trigger the SMI. Therefore, it is desired to firstly determine whether the SMI is triggered by a keyboard event or a mouse event. To be specific, the byte “5” at port 0x64 indicates that the SMI is triggered by a mouse event. Since the technical solution of the present invention is directed to the security of the data input via a character input device such as a keyboard, etc., no special processing is performed for the mouse event, but rather a next SMI is waited.

With the development of computer technologies, more and more data input devices are coupled to the computing device via a USB interface. In one embodiment of the present invention, the data input device is a keyboard which is coupled to the computing device via a USB interface, and the step of reading the data input via the data input device in the SMM comprises reading the data from the USB interface.

The USB provides an external bus standard, and the external device may be connected to the computing device based on the standard and communicate with the computing device. In various embodiments of the present invention, a person skilled in the art may cause the firmware to read, from the USB interface, the data input by the user via a USB keyboard based on the data communication format of the USB.

A person skilled in the art will understand that in the description above, a specific example for coupling the data input device to the computing device includes a PS/2 interface and a USB interface. A person skilled in the art may also cause the firmware to read the input data via a data input device coupled to the computing device via any other interface.

In the context of the present invention, a plurality of users may simultaneously access the remote server (for example, a plurality of users are simultaneously accessing the website of a bank), and each user may input a plurality of pieces of sensitive data (for example, different sensitive data such as accounts and passwords). Therefore, in this case, for further differentiation, different sensitive data may be differentiated based on a session identifier.

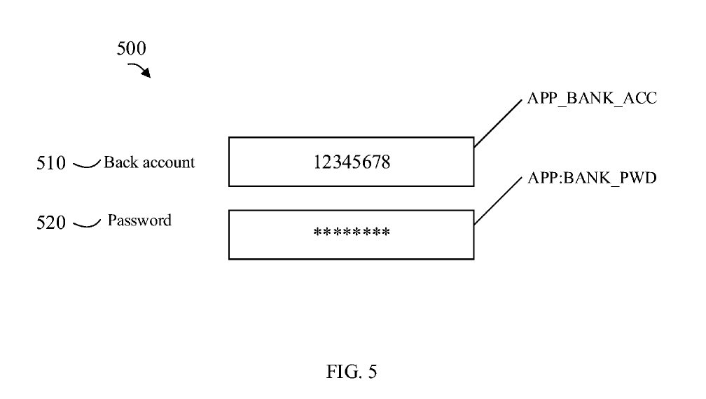

In one embodiment of the present invention, the method further comprises receiving a session identifier of a session associated with the remote server, and attaching the session identifier to the encrypted data. Now, detailed description is given with reference to FIG. 5. FIG. 5 is a schematic diagram 500 of a session identifier according to an embodiment of the present invention. To be specific, as illustrated in FIG. 5, assume that a user is accessing the website of a bank, and desires to input a bank account code (or username) 510 and a password 520. Since the bank account code 510 and the password 520 are different data, the data may be differentiated by using session identifiers “APP_BANK_ACC” and “APP_BANK_PWD” respectively. Further, when a plurality of users simultaneously access the website of a bank, a portion for identifying user identity may be added in the session identifier, such that a unique session identifier may be defined for each piece of data input by each user.

To be specific, after the user inputs bank account code “12345678”, the input bank account code “12345678” may first be encrypted by the firmware, and then the operating system accesses the encrypted data, and the session identifier “APP_BANK_ACC” indicates that the encrypted data is the bank account code input by the user. The session identifier may be attached to the encrypted data, and then the encrypted data is sent to the remote server. The remote server may decrypt the received data, and it may be known from the session identifier “APP_BANK_ACC” that the received data is the bank account code input by the user. In this embodiment, since the session identifier clearly depicts what the encrypted data is, the remote server may quickly determine the meaning of the received data.

It should be noted that the term “attach” or “attaching” described above has an extensive meaning, and a person skilled in the art may insert a session identifier before, in the middle of or after an original bank account code input by a user, such that the bank account code and the session identifier are encrypted together. Alternatively, the session identifier may also be inserted before, in the middle of or after an encrypted bank account code or the like. In various embodiments of the present invention, the step of “attaching” is not specifically limited. It is only required that sensitive data input by the user and a session identifier for identifying the sensitive data are encapsulated in one or a plurality of data packets, and the one or a plurality of data packets are transmitted to the remote server.

It should be noted that the session identifier described above is merely an exemplary example, and a person skilled in the art may design other embodiments according to the specific application environment. For example, a person skilled in the art may define a session identifier in other manners, and may extend the definition of the session identifier such that other information is added thereto. In one embodiment of the present invention, a corresponding processing mechanism needs to be configured at a remote server, such that the remote server is capable of identifying which user has input the currently received encrypted data and what is the currently received encrypted data, such that the remote server may employ a corresponding decryption process to obtain the sensitive data input by the user.

In addition, a person skilled in the art will understand that the actions of inputting sensitive data by the user may be continuous (for example, continuously inputting eight digits of a bank account code), or may be non-continuous (for example, during inputting of the bank account code, other mouse operations are performed by the user, or the input focus is moved to another position and other information is thus input). Therefore, a person skilled in the art may design different embodiments based on requirements of the specific application environment.

For example, when is the firmware detects that the input focus of the user is constantly located in an input field of “account” and the user has continuously input eight digits, after the eight digits are received, the bank account code formed by the eight digits may be encrypted and the encrypted bank account code is sent to the remote server. Optionally, each time the firmware detects that the user has input a digit, the input digit may be independently encrypted and the encrypted digits may be sent one-by-one to the remote server. In a further option, one or a plurality of digits input by the user are encrypted, and in one or a plurality of sending operations, the one or a plurality of encrypted digits are sent to the remote server.

In one embodiment of the present invention, the method further comprises receiving at least one of a timestamp and a sequence number associated with the data, and attaching at least one of the timestamp and the sequence number to the encrypted data.

In one embodiment of the present invention, to prevent the case of transmission errors due to network factors, a timestamp associated with the data may be received, such that the remote server, upon receiving the encrypted data, determines, according to the timestamp, how to process the received encrypted data. In one embodiment of the present invention, when only one piece of data (for example, a character) input by the user in each data packet is transmitted to the remote server, a sequence number (that is, the specific rank of the character input by the user) of the data may be received, such that the remote server, upon receiving each independent character, may assemble the data according to the sequence number to obtain an original sequence of the user's inputs.

For example, when the user inputs bank account code “12345678”, the sequence number of character “1” may be “1”, the sequence number of character “2” may be “2”, . . . , and the sequence number of character “8” may be “8”. Even if the remote server receives all the independent characters out of order, the remote server may still identify, according to the sequence numbers 1 to 8, that bank account code “12345678” was input by the user. Similar to the description given above, a person skilled in the art may cause the firmware or the operating system to attach at least one of the timestamp and the sequence number to the encrypted data in any manner.

In one embodiment of the present invention, the method further comprises storing the encrypted data in a memory cache, wherein the memory cache is accessible by the operating system layer. In embodiments of the present invention, the encrypted data may be transmitted between the firmware layer and the operating system layer by using the memory cache even though the operating system layer and the firmware layer are independent of one another. The operating system is capable of accessing the memory cache. Therefore, the firmware layer may store the encrypted data to the memory cache, such that the operating system layer may access the encrypted data. In this manner, the security of the sensitive data input by the user is ensured, and the encrypted data may be sent to the remote server via the operating system layer.

In one embodiment of the present invention, the memory cache may be a storage space in the UEFI. It may be defined in the storage space that a predefined variable name is used to store the encrypted data. For example, the variable name may be defined based on a Globally Unique Identifier (GUID) and/or a UEFI variable name, or may be defined by using another approach, as long as the firmware layer and the operating system layer in the computing device know the variable name in advance.

It should be noted that, in the context of the present invention, the user of the computing device may access the website of a bank, and a plurality of variables may be defined in the memory cache based on the GUIDs of the remote servers of various banks, such that data associated with each bank is stored in each of the plurality of variables.

According to the method described with reference to FIG. 3 to FIG. 5, even if a malicious program is present on the computing device and/or the network, the malicious program is only capable of accessing the encrypted form of the sensitive data, and is incapable of obtaining the sensitive data originally input by the user. Therefore, the security of the sensitive data is ensured. Further, after the remote server receives the encrypted data from the computing device, a decryption operation may be performed according to a decryption method corresponding to the encryption method, such that the original data input by the user is restored.

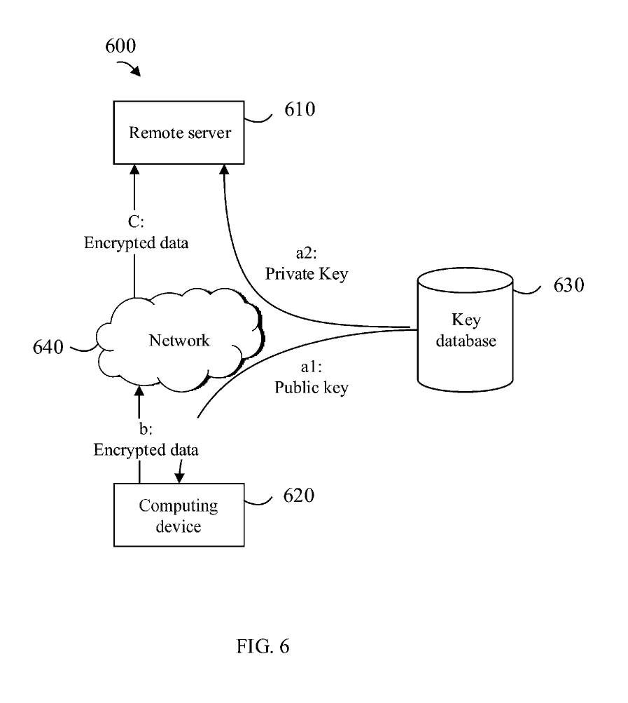

FIG. 6 is a schematic diagram 600 of interactions among devices via a network according to an embodiment of the present invention. As illustrated, an encryption algorithm to be employed may be negotiated in advance between a remote server 610 and a computing device 620, and a key (for example, a public key and a private key) may be stored in advance in a key database 630. In the embodiments of the present invention, whether the key database is independent of the remote server 610 is not limited. However, the key database 630 may be located at the same position as the remote server 610, or the key database 630 may be a third-party database (for example, an encryption algorithm provider) independent of the remote server 610 and the computing device 620.

The computing device 620 may receive from the key database 630 a public key (as illustrated by arrow a1) for encrypting data, and the firmware layer may receive the data from the data input device and encrypt the received data. Afterwards, the computing device 620 may send the encrypted data to the remote server via a network 640 (as illustrated in arrows b and c). Subsequently, the remote server 610 may decrypt the received encrypted data based on a private key received as illustrated by arrow a2. In this manner, even if a malicious program is present on the computing device 620 and/or the network 640, the security of the sensitive information input by the user via the data input device is still ensured.

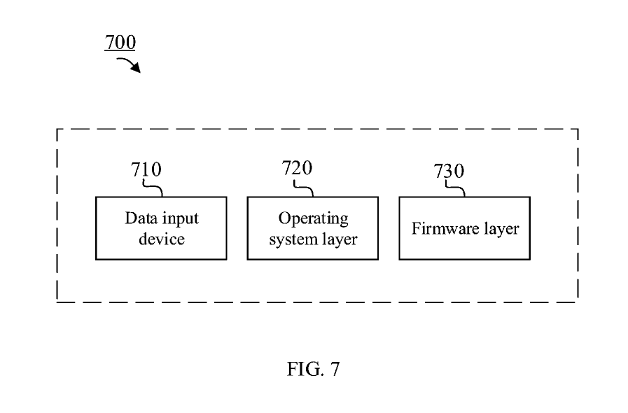

FIG. 7 is a block diagram 700 of a computing device for encrypting data according to an embodiment of the present invention. The computing device comprises a data input device 710, an operating system layer 720, and a firmware layer 730. The firmware layer 730 is operable to receive data input via the data input device 710, the data being inaccessible by an operating system layer 720, the data is to be sent to a remote server (see FIG. 3), and the firmware layer 730 being independent of the operating system layer 720. The firmware layer is further operable to encrypt the received data such that the operating system layer sends the encrypted data to the remote server.

In one embodiment of the present invention, the firmware layer 730 may be operable to receive the data based on a SMI having a priority higher than a priority of performing an operation on the operating system layer.

In one embodiment of the present invention, the firmware layer 730 may be operable to enable a SMM in response to detection of the SMI in the computing device, and read the data input via the data input device in the SMM.

In one embodiment of the present invention, the data input device 710 is a keyboard coupled to the computing device via a personal system 2 interface, and the firmware layer 730 may be operable to read the data from a second port of the personal system 2 interface in response to a byte, indicating that the SMI is triggered by a keyboard event, from a first port of the personal system 2 interface.

In one embodiment of the present invention, the firmware layer 730 may be operable to wait for a next SMI in response to the byte from the first port indicating that the SMI is triggered by a mouse event.

In one embodiment of the present invention, the data input device 710 is a keyboard coupled to the computing device via a USB interface, and the firmware layer 730 is operable to read the data from the USB interface.

In one embodiment of the present invention, the firmware layer 730 may be operable to receive a session identifier of a session associated with the remote server, and attach the session identifier to the encrypted data.

In one embodiment of the present invention, the firmware layer 730 may be operable to receive at least one of a timestamp and a sequence number associated with the data, and attach at least one of the timestamp and the sequence number to the encrypted data.

In one embodiment of the present invention, the computing device may further comprise a memory cache configured to store the encrypted data, the memory cache being accessible by the operating system layer.

Still another embodiment of the present invention provides an apparatus. The apparatus may comprise a data input device, and a data acquiring module configured to receive data input via a data input device, the data being inaccessible by an operating system layer and the data is to be sent to a remote server. The apparatus further comprises a firmware layer that is independent of an operating system layer, and a data encrypting module configured to encrypt the received data at the firmware layer such that the operating system layer sends the encrypted data to the remote server.

In one embodiment of the present invention, the data acquiring module comprises an interrupting module configured to receive the data input via the data input device and provide the data input to the firmware layer based on a SMI having a priority higher than a priority of performing an operation on the operating system layer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving data input via a data input device at a firmware layer of a computing device, the data being inaccessible by an operating system layer of the computing device, the data is to be sent to a remote server, and the firmware layer being independent of the operating system layer;
encrypting the received data on the firmware layer; and
the operating system layer sending the encrypted data to the remote server.

2. The method of claim 1, wherein receiving data input via a data input device comprises:
receiving the data at the firmware layer based on a System Management Interrupt having a priority higher than a priority of performing an operation on the operating system layer.

3. The method of claim 2, wherein receiving the data at the firmware layer based on a System Management Interrupt comprises:
enabling a System Management Mode in response to detecting the System Management Interrupt in the computing device; and
reading the data input via the data input device in the System Management Mode.

4. The method of claim 3, wherein the data input device is a keyboard coupled to the computing device via a personal system 2 interface, and wherein reading the data input via the data input device in the System Management Mode comprises:
indicating that the System Management Interrupt was triggered by a keyboard event in response to a byte from a first port of the personal system 2 interface; and
reading the data from a second port of the personal system 2 interface.

5. The method of claim 4, wherein reading the data input via the data input device in the System Management Mode further comprises:
indicating that the System Management Interrupt is triggered by a mouse event in response to the byte from the first port; and
waiting for a next System Management Interrupt.

6. The method of claim 3, wherein the data input device is a keyboard coupled to the computing device via a universal serial bus interface, and wherein reading the data input via the data input device in the System Management Mode comprises:
reading the data from the universal serial bus interface.

7. The method of claim 1, further comprising:
receiving a session identifier of a session associated with the remote server; and
attaching the session identifier to the encrypted data prior to sending the encrypted data to the remote server.

8. The method of claim 1, further comprising:
receiving at least one of a timestamp and a sequence number associated with the data; and
attaching at least one of the timestamp and the sequence number to the encrypted data prior to sending the encrypted data to the remote server.

9. The method of claim 1, further comprising:
the firmware layer storing the encrypted data in a memory cache that is accessible to the operating system layer.

10. A computing device, comprising:
a data input device;
an operating system layer; and
a firmware layer, operable to:
receive data input via a data input device, the data being inaccessible by an operating system layer, the data is to be sent to a remote server, and the firmware layer being independent of the operating system layer; and
encrypt the data received by the firmware layer such that the operating system layer sends the encrypted data to the remote server.

11. The computing device of claim 10, wherein the firmware layer is operable to:
receive the data based on a System Management Interrupt having a priority higher than a priority of performing an operation on the operating system layer.

12. The computing device of claim 11, wherein the firmware layer is operable to:
enable a System Management Mode in response detecting the System Management Interrupt; and
read the data input via the data input device in the System Management Mode.

13. The computing device of claim 12, wherein the data input device is a keyboard coupled to a personal system 2 interface, and the firmware layer is operable to:
indicate that the System Management Interrupt is triggered by a keyboard event in response to a byte from a first port of the personal system 2 interface and read the data from a second port of the personal system 2 interface.

14. The computing device of claim 13, wherein the firmware layer is operable to:
indicate that the System Management Interrupt is triggered by a mouse event in response to the byte from the first port and wait for a next System Management Interrupt.

15. The computing device of claim 12, wherein the data input device is a keyboard coupled to a universal serial bus interface, and the firmware layer is operable to:
read the data from the universal serial bus interface.

16. The computing device of claim 10, wherein the firmware layer is operable to:
receive a session identifier of a session associated with the remote server; and
attach the session identifier to the encrypted data.

17. The computing device of claim 10, wherein the firmware layer is operable to:
receive at least one of a timestamp and a sequence number associated with the data; and
attach at least one of the timestamp and the sequence number to the encrypted data.

18. The computing device of claim 10, wherein the method further comprises:
a memory cache configured to store the encrypted data, the memory cache being accessible by the operating system layer.

19. An apparatus, comprising:
a data input device;
a data acquiring module configured to receive data input via a data input device, the data being inaccessible by an operating system layer, the data is to be sent to a remote server, and the firmware layer being independent of the operating system layer; and
a data encrypting module configured to encrypt the data received by the firmware layer such that the operating system layer sends the encrypted data to the remote server.

20. The apparatus of claim 19, wherein the data acquiring module comprises:
an interrupting module configured to receive the data input via the data input device and provide the data input to the firmware layer based on a System Management Interrupt having a priority higher than a priority of performing an operation on the operating system layer.
